(19) United States
(12) Patent Application Publication
(10) Pub. No.: US 2021/0277682 A1
(43) Pub. Date: Sep. 9, 2021

(54) A METHOD OF MANUFACTURING PSEUDO-CONJUGATED PRECAST CONCRETE SEGMENTS

(71) Applicant: SOLETANCHE FREYSSINET, Rueil Malmaison (FR)

(72) Inventor: Jean-Daniel LEBON, Saint Germain en Laye (FR)

(21) Appl. No.: 16/499,976

(22) PCT Filed: Apr. 18, 2017
(86) PCT No.: PCT/IB2017/000567

§ 371 Date: Oct. 1, 2019

(51) Int. Cl. E04H 12/12; E04H 12/34; E04H 12/16; E04B 1/16

(52) U.S. Cl. CPC E04H 12/12; E04H 12/342; F03D 13/20; E04H 12/341; E04B 1/167; E04H 12/16

(57) ABSTRACT

A method of manufacturing precast concrete segments destined to form all or part of a tower (2), the segments being destined to be superimposed within the tower.

The method comprises, for at least a first segment and a second segment destined to be adjacent in the tower, the first segment being destined to be located beneath the second segment, forming said first and second segments using at least one mould comprising a first portion (Ti) and a second portion (Bi) respectively configured to define all or part of an upper face, respectively a lower face of the segment formed therein, the first portion of the mould used for forming the first segment and the second portion (Bi) of the mould (Mi) used for forming the second segment exhibiting respective geometries of complementary shapes.

The invention relates to the manufacturing of precast concrete segments, such as those used for forming a tower destined to receive a wind turbine.

Typically, such towers include a vertical column which includes superimposed concrete segments, which for instance have a general annular shape.

For the construction of the tower, the segments are installed on top of each other, the interface between two adjacent segments being provided with a joint, for instance formed using a grout, a resin, etc.

Given the elevated configuration of such towers and the forces which apply to them during their lifetime, designing the interfaces between the various segments, in particular so as to prevent the top segment from leaning relative to the bottom segment and/or from being out of plumb relative to the latter, can prove critical.

The main technique which is used to that end lies in forming the various segments using one or more mould in which at least one of the portions which are destined to form the top and bottom faces of the segments are defined by the lower, respectively the upper face of each segment which is destined to be adjacent to the considered segment within the tower.

This process has major drawbacks. In particular, the possible sequences which may be used to form the various segments are limited, as the latter must be formed in a specific order, thereby defining heavy constraints on the project planning.

In addition, the segments may be very heavy, bulky and fragile, whereby this technique is very demanding in terms of segment handling.

The invention seeks to improve the situation.

To this end, the invention relates to a method of manufacturing precast concrete segments destined to form all or part of a tower, the segments being destined to be superimposed within the tower, the method comprising, for at least a first segment and a second segment destined to be adjacent in the tower, the first segment being destined to be located beneath the second segment, forming said first and second segments using at least one mould comprising a first portion and a second portion respectively configured to define all or part of an upper face, respectively a lower face of the segment formed therein, the first portion of the mould used for forming the first segment and the second portion of the mould used for forming the second segment exhibiting respective geometries of complementary shapes.

According to an aspect of the invention, the method further comprises a step of manufacturing the first portion of the mould used for forming the first segment and the second portion of the mould used for forming the second segment, wherein at least one of the first portion of the mould used for forming the first segment and the second portion of the mould used for forming the second segment is formed in contact with the other one among the first portion of the mould used for forming the first segment and the second portion of the mould used for forming the second segment so as to form the respective geometries of complementary shapes.

According to an aspect of the invention, the first portion of the mould used for forming the first segment and the second portion of the mould used for forming the second segment are simultaneously formed in contact with one another.

According to an aspect of the invention, a first element among the first portion of the mould used for forming the first segment and the second portion of the mould used for forming the second segment is initially made and a second element among the first portion of the mould used for forming the first segment and the second portion of the mould used for forming the second segment is made by casting using a mould which includes the first element configured so as to generate the geometry of the second element by shape complementarity.

According to an aspect of the invention, the respective geometries of the upper face of the first segment and of the lower face of the second segment define at least one shear key when cooperating with one another.

According to an aspect of the invention, the shear key is defined by a mortise and a tenon respectively defined within one element among the upper face of the first segment and the lower face of the second segment.

According to an aspect of the invention, the first portion of the mould used for forming the first segment and the second portion of the mould used for forming the second segment define the entirety of the corresponding face of the corresponding segment.

According to an aspect of the invention, the segments have a general cylindrical shape, the first portion of the mould used for forming the first segment and the second portion of the mould used for forming the second segment each including a plurality of components which are assembled together to cover the entire circumference of the corresponding face of the corresponding segment.

According to an aspect of the invention, the first portion of the mould used for forming the first segment and the second portion of the mould used for forming the second segment define solely part of the corresponding face of the corresponding segment.

According to an aspect of the invention, the first portion of the mould used for forming the second segment exhibits a geometry having a shape complementary to that of a geometry of a second portion of a mould used for forming a third segment destined to be adjacent to the second segment within the tower and to be located above the second segment, said second portion of the mould used for forming the third segment being configured to define a lower face of the third segment.

According to an aspect of the invention, the mould used for forming the first segment and the mould used for forming the second segment are a same mould.

According to an aspect of the invention, the mould used for forming the first segment and the mould used for forming the second segment are different moulds.

According to an aspect of the invention, at least for one considered segment among the first or second segment, an angle defined between an upper average plane defined by the upper face of the considered segment and a lower average plane defined by the lower face of the considered segment is inferior to 0,5 milliradian.

According to an aspect of the invention, at least for one considered segment among the first or second segment, the drift of said considered segment, which corresponds to a vertical misalignment between the upper face and the lower face of the segment Si, is inferior to 5 mm.

The invention also relates to a method of manufacturing a tower, the tower comprising a plurality of superimposed precast concrete segments, the method comprising:
using the method according to any one of the preceding claims, manufacturing at least a first and a second segments destined to be adjacent in the tower, the first segment being destined to be located underneath the second segment, and
superimposing the segments including the first and second segments to form the tower.

Other features and advantages of the manufacturing process disclosed herein will become apparent from the following description of non-limiting embodiments, with reference to the appended drawings, in which:

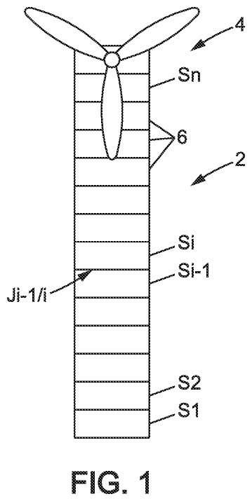

FIG. 1 is an illustration of a tower built using a method according to the invention;

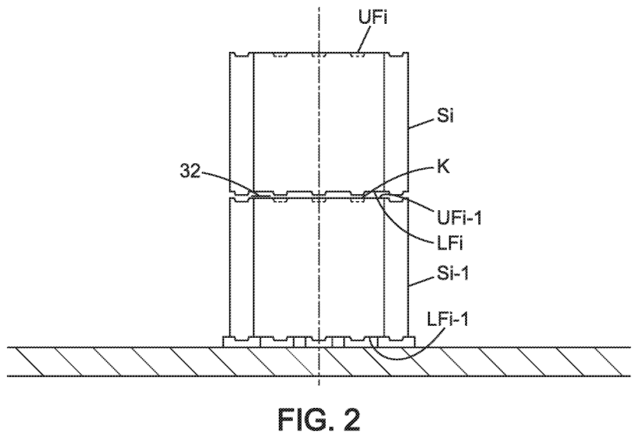

FIG. 2 illustrates precast concrete segments made using a method of manufacturing concrete segments according to the invention;

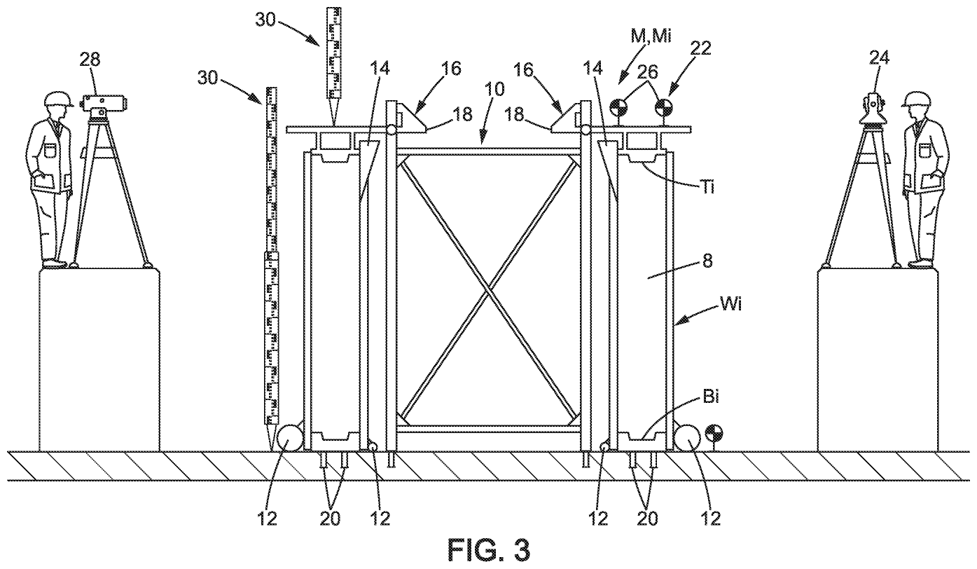

FIG. 3 illustrates an apparatus for forming concrete segments used in the method according to the invention;

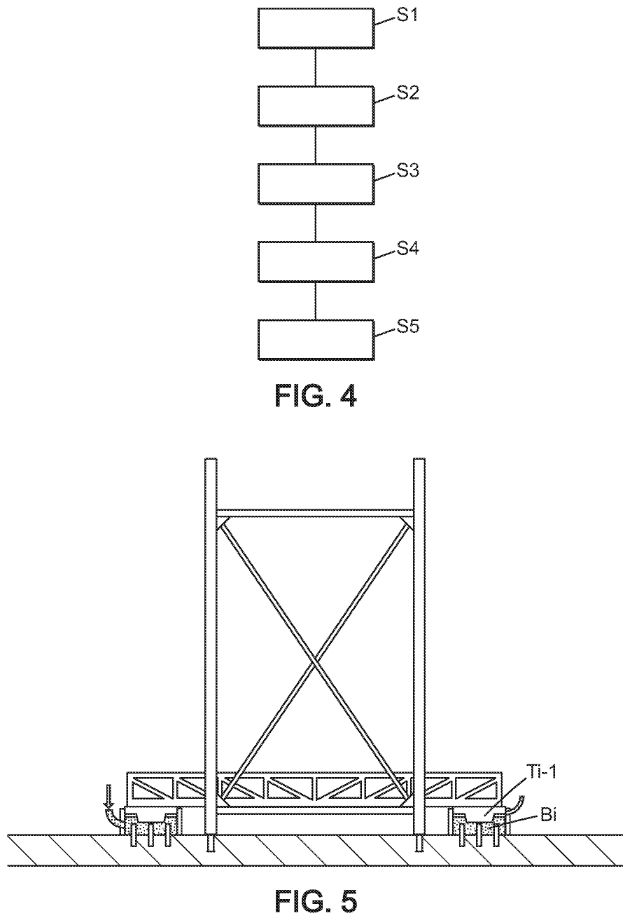

FIG. 4 is a block-diagram illustrating the method of manufacturing precast concrete segments according to the invention and a method of building a tower according to the invention;

FIG. 5 illustrates a method of manufacturing mould portions used in the method according to the invention; and

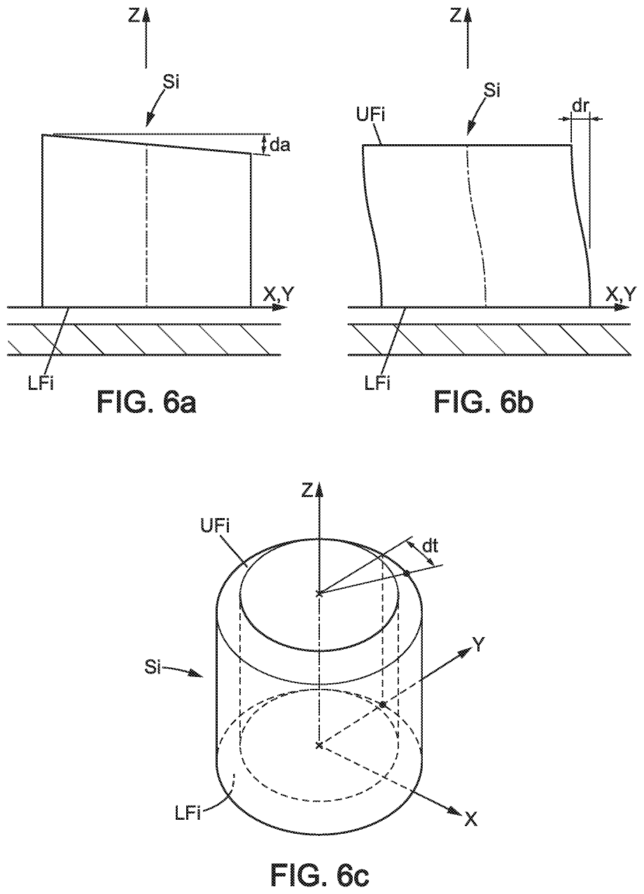

FIGS. 6a to 6c illustrate an inclination angle, or slant angle, a drift and a torsion of a concrete segment.

FIG. 1 illustrates a tower 2 resulting from a manufacturing process according to the invention.

The tower 2 is destined to support a wind turbine nacelle 4. The assembly of the tower and the wind turbine nacelle forms an electrical power generation apparatus.

The tower 2 includes a plurality of superimposed segments 6 of respective references Si, where i is an integer varying from 1 to n, n being strictly greater than 1. The integer n is for instance greater than 10 or 20, or even than 30.

In the context of the invention, the segments 6 are precast concrete segments. In other words, they are made of concrete and are manufactured prior to their being installed within the tower.

Optionally, the segments are made of reinforced concrete. Alternatively or additionally, the concrete of the segments may be prestressed.

Advantageously, each segment has a general cylindrical configuration having a central cavity.

Advantageously, the shape of the segments is annular, whereby the segments are revolution structures.

Alternatively, they may have a shape with a section other than a circle, such as a polygonal section, an elliptic section, etc.

The segments may have a straight cylindrical configuration. In such a configuration, the tower may present a straight cylindrical configuration.

Alternatively, the segments, or at least some of them, may have a frustoconical shape, the radius of the upper faces of the segments being less than the radius of their lower faces.

It should be noted that combined configurations, in which part of the tower is straight, and another part is frustoconical, are envisaged.

For a tower of at least 100 meters in height, the segments may have a diameter of several meters, such as one comprised between 2 and 10 meters, and advantageously between 4 m and 8 m.

Moreover, the height of the segments is for instance chosen between 2 m and 4 m.

In addition, the segments each have a mass of several tons, such as a mass chosen between 10 tons and 150 tons.

In the context of the invention, at least part of the segments 6 are made using a manufacturing method according to the invention described hereinafter, and advantageously all are.

FIG. 2 illustrates two of the segments Si-1 and Si, which are destined to be adjacent in the tower 2, the segment Si being destined to be located on top of the segment Si-1.

Each segment Si has an upper face UFi and a lower face LFi, destined to be in contact with the lower face LFi+1, respectively the upper face UFi-1 of the corresponding adjacent segment Si+1, respectively Si-1.

The interface Ii-1/i defined by the faces UFi-1 and LFi of the segments Si-1, Si defines a joint Ji-1/i between the two segments Si-1, Si.

Within the tower 2, the joint Ji-1/i may include further components such as a hardened grout, an adhesive material, and the like.

As described below, the respective faces of two adjacent segments which face each other and are formed by the method according to the invention, have respective geometries of complementary shape.

In this context, advantageously, the upper face UFi-1 and the lower face LFi of the segments Si-1, Si define at least one shear key K when cooperating with one another. The shear key K is configured to take up shearing forces which apply to the joint Ji-1/i and/or to ensure their correct relative positioning.

For instance, this shear key is defined by a mortise and a tenon respectively borne by the considered faces. The tenon and mortise may be borne by any of the two faces, one face having the tenon whereas the other face has the mortise.

The upper face UFi-1 and the lower face LFi of the segments Si-1, Si may define a plurality of such shear keys.

Optionally, the faces UFi-1 and LFi are revolution surfaces with an inclined generatrix, i.e. they have conical annular surfaces (this is illustrated in FIG. 6c). In other words, when considering a radial section of the segment/tower, the upper or lower edge of the section has a transversal slope.

A given conical annular face may radially extend upward, i.e. slope down toward the center of the segment. Alternatively, it may radially extend downward, i.e. slope up toward the center of the segments.

When one of the faces UFi-1, LFi slopes down, the other face slopes up given their shape complementarity.

The slopes of the faces are advantageously inferior to 45°.

The methods of manufacturing precast concrete segments and of manufacturing a tower according to the invention will now be described in details.

In a general manner, the method of manufacturing concrete segments according to the invention is used to manufacture at least two adjacent segments Si-1 and Si in the tower, the segment Si being located above the segment Si-1, so that the upper face UFi-1 of segment i-1 has a geometry complementary to that of the lower face LFi of segment Si. Advantageously, all of the segments are manufactured using the method according to the invention.

For the sake of brevity, the method will only be described for the two adjacent segments Si-1 and Si, corresponding operations being also carried out for the rest of the segments which are manufactured according to the method of the invention.

As illustrated on FIG. 3, for the purpose of the method, at least one mould M is used for manufacturing the segments Si-1 and Si.

A single mould M may be used, for instance in particular if all the segments are identical. Alternatively, in this context, a plurality of identical moulds M may be used, for instance so as to speed up the process of manufacturing the various identical segments.

Alternatively, different moulds may be used, such as a dedicated mould for a given segment within the tower. It should be noted that a given mould may however be used for manufacturing various identical segments which respectively belong to different towers, for instance in contexts in which a plurality of towers 2 are built in a given vicinity.

So as to encompass all the possibilities, a mould used for manufacturing a segment Si will be indexed by i, its reference sign thus being Mi. Moulds Mi-1 and Mi may thus be different moulds, or a same mould.

In reference to FIG. 3, a mould Mi includes a first portion Ti, a second portion Bi, and wall portions Wi.

The first portion Ti, the second portion Bi and the wall portions Wi define at least part of a formwork configured, when assembled together, to define an inner cavity 8 having the shape the considered segment is destined to have once cast using the mould Mi.

The first portion Ti is configured to define all or part of the upper face UFi of the segment Si built in the mould Mi. In other words, the first portion Ti forms a part of the formwork which is configured to define a wall of the cavity which will give the upper face UFi its geometry by shape complementarity.

In a first configuration, the first portion Ti is configured to define the entirety of the upper face UFi. In other words, it is configured to cover the entire circumference of the cavity 8.

In this configuration, for instance, the first portion Ti includes a continuous element destined to be turned toward the cavity 8 for forming the entire upper face UFi of segment Si.

Alternatively, the first portion Ti includes a plurality of components which are assembled together to cover this entire circumference.

For instance, the first portion Ti includes panels which are assembled together over the circumference of the cavity. For instance, the first portion thus includes primary panels which cover part of the circumference of the cavity, for instance 2, 3, 4 or more of such panels. The primary panels are for instance regularly spaced around the circumference. In addition, the first portion Ti includes secondary panels which each stretch between two primary panels, and are secured to the primary panels. Any known means may be used to connect the secondary panels to the primary panels.

As discussed below, the primary panels are advantageously fastened to a support structure 10 detailed below and are movable relative to the other components of the mould via the support structure, in particular so as to ease the removal of the segment Si once it has been formed.

In a second configuration, the first portion Ti defines only part of the upper face UFi of the segment Si. For instance, it thus includes panels which are spaced apart around the circumference of the cavity 8. In other words, in reference to the configuration above having primary and secondary panels, the first portion Ti may thus only include the primary panels above, the space occupied by the secondary panels for instance being left unoccupied.

The second portion Bi is configured to define all or part of the lower face LFi of the segment Si. In other words, the second portion Ti forms a part of the formwork which is configured to define a wall of the cavity which will give the lower face LFi its geometry by shape complementarity.

As for the first portion, in a first configuration, the second portion defines the entire lower face LFi of the segment Si. It may thus include a continuous component turned toward the cavity, or a plurality of components which are for instance fastened together. In a second configuration, it may solely define part of the lower face LFi, and may present a configuration similar to that of the first portion in the analogous configuration.

Advantageously, the portion Bi is fixed relative to the ground. For instance, it is fastened thereto by connectors 20, which are for instance inserted in the ground. The ground in question may correspond to a slab, for instance located in a factory.

The manufacture of the first portion Ti and second portion Bi is detailed below.

The walls portions Wi are configured to jointly define the inner and outer walls of the segments Si by shape complementarity.

The wall portions Wi include one or more inner panel configured to define the inner walls of the segment Si, and one or more outer panel configured to define the outer walls of the segment Si.

Advantageously, the wall portions include at least two inner panels and/or at least two outer panels.

Advantageously, at least some of the panels of the wall portions Wi may move relative to the other components of the mould Mi. For instance, the corresponding panels are provided with displacement means 12 which includes wheels, rollers or the like.

At least one of the panels of the wall portions Wi is provided with one or several openings, or shafts, 14 for the pouring of concrete into the cavity 8 so as to form the segment Si.

The mould Mi is advantageously coupled to a support structure 10. The support structure is for instance located in a central position relative to the mould Mi, whose elements are located around and/or onto the support structure 10.

The mould Mi and the corresponding support structure 10 form a segment production unit, sometimes referred to as a cell.

Advantageously, the first portion Ti is fastened to the support structure 10.

In a first configuration in which the first portion Ti includes a plurality of components, such as primary panels and optionally secondary panels as well, the support structure 10 includes a plurality of articulated arms 16 to which at least some of the panels are connected.

For instance, a given arm 16 is associated to a single panel of the first portion. Advantageously, each arm 16 is adapted to rotate about an axis via which the arm is connected to the rest of the support structure.

The arms 16 may be provided with an abutment portion 18 configured to abut against an element of the support structure so as to define an abutment configuration in which the first portion is in the desired position to define the upper face of the segment Si. All or part of the articulated arms 16 may be equipped with a tuning device, such as a screw-type device, allowing an accurate adjustment of their position. As described below, this may be put to use in relation with geometrical surveys and controls carried out during the process according to the invention.

Advantageously, this configuration is employed when the first portion Ti solely defines part of the upper face UFi. The primary panels are thus each supported by a given arm.

In an alternative configuration, in particular for embodiments in which the first portion Ti includes a continuous component over the entire circumference of the cavity, or a plurality of components connected together, the support structure includes a beam structure to which the first portion Ti is fastened, the beam structure being adapted to displace the first portion up and down relative to the rest of the support structure 10.

The details of the methods of manufacturing segments and building a tower according to the invention will now be given in view of FIG. 4.

In a general manner, a core aspect of the invention lies in that the first portion Ti-1 of the mould Mi-1 used for forming the segment Si-1 and the second portion Bi of the mould Mi used for forming the segment Si have respective geometries which are of complementary shape.

In a first step S1, the first portion Ti-1 and the second portion Bi are manufactured, at least one of them being formed in contact with the other one so that they acquire their respective complementary shape.

In other words, during the manufacturing process of these portions, the two portions are in contact with one another while at least one is being formed.

In effect, either the two portions are simultaneously formed in contact with one another, or one is initially made and the other one is formed using the already made portion so that the other portion acquires a geometry having a complementary shape relative to the portion already made.

In the context of a simultaneous formation, the two portions are gradually formed using parts which are assembled together to define the two portions. For instance, the parts include profiles and/or frames made of metal. The parts are for instance assembled using a mechanical welding process. For instance, once the various parts have been assembled together, the two portions which are thus obtained are initially fastened to one another. An operation of separating the two portions is then carried out.

For instance, the portions are then formed around the location of the support structure 10 coupled to the mould Mi, the portion Bi being formed directly in contact with the connectors 20 so that it is placed in its operational position. Alternatively, they are formed and then the portion Bi is connected to the connectors 20. It should be noted that the support structure 10 may be installed beforehand, or after.

In the context of the sequential formation of the portions, one portion is initially made, for instance the portion Ti-1. Any process may be used to that end, such as a mechanical welding process whereby parts are assembled together to form the portion. The portion Ti-1 may thus be made of metal.

During a following operation, the other portion, here portion Bi, is formed by casting using a mould which includes the formed portion, here Ti-1, which is then configured so as to define the geometry of the portion to be formed and convey it its shape complementarity (relative to the already formed portion).

For instance, in reference to FIG. 5, this operation is optionally carried out so that the obtained portion Bi is already connected to the connectors 20 of mould Mi.

In any case, a formwork defining an inner cavity having the desired configuration for the portion to be formed is defined, the portion Ti-1 being used as a component of this formwork, the region of the portion Ti-1 to which the portion Bi is to be complementary in shape being turned toward the cavity.

A hardenable material, such as concrete, is then injected into this inner cavity so as to flesh out the portion Bi. The formwork, in particular the portion Ti-1, is then removed once the portion Bi has hardened.

This step is carried out for all the portions Ti-1 and Bi of moulds which are destined to form segments by a method according to the invention, with the exception of the portions B1 and Tn, which are not destined to form faces which are to be in contact with another segment.

For instance, the same step is carried out for the portions Bi-1 and Ti-2, Bi-2 and Ti-3, etc . . . , as well as for the portions Ti and Bi+1, Ti+1 and Bi+2, etc.

It should be noted that this step may be carried out entirely before any further step is carried out, or further steps may start/be completed before this step is finished, e.g. some portions may be formed while others which are already manufactured are used to form, i.e. cast the corresponding segments.

During a step S2, the various portions of the mould Mi-1 and/or the mould Mi are put in place for forming the corresponding segment.

In effect, the details of this step depend on whether the mould Mi-1 and Mi are a same mould or not.

If they are, only one, for instance mould Mi, is put in place at a given time.

If they are not, they may be put in place in parallel or sequentially.

The following description focuses on a single mould, here mould Mi.

During this step, the bottom portion Bi is put in place, and is for instance connected to the connectors 20 if it was not beforehand.

In addition, the portion Ti is connected to the support structure 10. For instance, it is connected to the arms 16, or to the beam structure (shown in FIG. 5).

In particular, when the portion Ti covers the entire circumference of the cavity, it is then connected to the beam structure. For instance, it is so when it is still in contact with the portion Bi and the mould Mi is identical to the mould Mi-1.

The beam is then lifted vertically to the desired position for the portion Ti to define the cavity 8.

In addition, when used, the arms 16 are rotated in the desired position, for instance defined by the abutment configuration discussed above.

During this step, the wall portions Wi are moved in position so as to define the lateral walls of the inner cavity 8. For instance, in this position, the wall portions are in abutment against the portions Bi and Ti.

Advantageously, the definition of the cavity by the mould Mi is controlled so that the angle defined between the average plane defined by the upper face UFi and the average plane defined by the lower face LFi of the segment Si is less than 0,5 milliradian (mrad), most advantageously less than 0,2 milliradian, and preferentially less than 0,1 milliradian.

In other words, by considering the respective planes which are defined by averaging the upper face and lower face, these planes are parallel with a high degree of precision.

This angle has the reference sign da on FIG. 6a.

In reference to FIG. 6b, advantageously, the drift dr of the segment, i.e. the vertical misalignment between the upper face UFi and the lower face LFi of the segment Si, is controlled so as to be inferior to 5 mm, most advantageously to 2 mm and preferentially to 1 mm.

In reference to FIG. 6c, advantageously, the torsion dt of the segment, i.e. the angle between the upper face UFi and the lower face LFi of the segment Si around a central axis of the segment, is controlled so as to be inferior to 5 mrad, most advantageously to 2 mrad and preferentially to 1 mrad.

This torsion represents the relative angular misalignment between respective reference azimuths of the upper and lower faces UFi and LFi. In effect, these azimuths are used for instance for positioning internal structures of the segments such as reinforcement elements which are arranged within their concrete, and/or tower components and pieces of equipment, such as prestressing cables or tendons, security entrances, and so on.

The angle da, the drift dr and the torsion dt are construction errors which result from the relative positioning of the portions Bi and Ti, and which are advantageously, in the context of the invention, sought to be reduced as much as possible.

Advantageously, to that end, the geometric configuration of the mould Mi is evaluated using one or more survey module 22 (FIG. 3), and is adjusted so as to obtain the desired configuration.

Advantageously, the survey module 22 is optical-based, its optical nature being advantageously used in conjunction with templates and/or gauges which are placed on and/or near the structure 10 and/or the mould.

For instance, at least one survey module include an optical instrument 24, or optical sensor 24, such as a theodolite, coupled to one or more reflective element 26, such as a 3D prism, arranged on the mould Mi and/or the support structure 10.

For instance, at least one reflective element 26 is located on one or more arm 16 or support beam (when used) to which the portion Ti is connected. At least one reflective element 26 may also be connected with the portion Bi and located at the foot of the mould. The optical instrument may be located on a survey tower at an appropriate height, and located at a distance from the mould, for instance a short distance.

Alternatively or in parallel, at least one survey module includes an optical instrument 28 (FIG. 3), such as an optical level, coupled to one or more levelling staff 30 which can be read using the optical instrument 28.

For instance, at least one staff 30 is positioned with its measuring tip on top of the arm 16 (or beam), and then positioned with its measuring tip close to the portion Bi, their common levelling benchmark being taken on the foot slab of the mould.

Alternatively or in parallel, at least one survey module includes one or more laser sensing device (not shown), for instance three or more of such devices, distributed on the circumference of portion Ti. They may be evenly distributed thereon. The laser sensing devices may be arranged on all or some of the arms 16 (or the beam structure), and may be configured to measure their heights and off plumbs relative to benchmarks positioned onto the floor of the casting cell/mould.

It should be noted that the various survey modules may be calibrated using one or more shared reference object, or shared reference benchmark, so as to ensure that the measurements of the survey modules are made in reference to a common referential.

In a specific embodiment, the optical instrument or laser of all or part of the survey modules are located above the support structure 10. For instance, they are located on a survey tower which extends vertically above the latter. For instance, the survey tower is secured thereto. This alleviates the need to calibrate the corresponding modules so as to manually define a common referential for their measurements.

Preferentially, whether in this embodiment or in another one, the structure 10 and the various components of the mould have a degree of stiffness adapted to prevent deformations thereof when used to manufacture the segments.

The survey of the configuration, in particular the position, of the mould Mi may be conducted at regular intervals, for instance before and/or after the manufacture (in particular the concrete pouring) of a segment and/or after a predetermined number of segment(s) has been made.

Depending on the result of the survey of the geometry of the mould, corrective actions may be implemented. These actions in particular include adjusting the position of the portion Ti using the beam structure or the arms 16.

The adjustment of the configuration of the mould may be carried out automatically and/or manually. In particular, the survey module 22 may be connected to a processing device coupled to actuators (not shown) and configured to command the latter for the adjustment of the configuration of the mould so that one or more predetermined parameter, such as the relative angle between average planes of the portions Bi and Ti and/or the drift of the segment, is within a predetermined range.

Advantageously, the survey of the configuration of the mould is carried out after the mould has been closed and is ready to be used for casting the segment.

During a step S3, concrete is inserted, for instance poured, in the cavity 8 using the opening(s) 14 of the mould Mi, so as to fill the cavity with it. The concrete is left to set and harden, thereby defining the segment Si.

During a step S4, the segment Si which has thus been formed is extracted from the mould Mi. For instance, the wall portions Wi are opened and moved, and the portion Ti is also moved away from the upper face UFi of the segment Si, using the arms 16 or beam structure. The segment is then moved away from the bottom portion Bi, for instance using a lifting device such as a crane.

Steps S2 to S4 are carried out for all the segments if all are to be made according to the method of the invention, or for instance by a known process for those which are not.

During a step S5, the tower is formed using at least the segments S1 to Sn, and in particular at least the segments Si-1 and Si which have been previously made.

To that end, the various segments S1 to Sn are superimposed, i.e. stacked, on each other, starting with segment Si which is put in place first. Segment S2 is then put on top of segment S1, segment S3 on top of segment S2, segment Si-1 on top of segment Si-2, segment Si is then put in place above the segment Si-1, and so on until segment Sn in in place.

Although not preferred, groups of segment may alternatively be superposed in parallel in a first step, and the groups of segments are then superposed on each other so as to form the tower.

In some embodiments, the segments may be assembled in a reverse order, starting with the top segment Sn up to segment Sk (1<k<n). The tower section Sk-Sn which is formed at a given time is then lifted so as to allow the positioning and the assembly of one or more of the following segments S1, . . . , Sk-1 beneath the lifted tower section Sk-Sn, upon which the lifted tower section is then lowered. This operation is repeated until all the segments are in place.

Any means may be used to the end of lifting the segments, such as a crane.

During step S5, whenever two segments are superimposed, the corresponding joint is defined. For instance, at least one hardenable material is used to that end.

Advantageously, the joint Ji-1/I includes an adhesive material 32 (FIG. 2). The adhesive material is preferably present over the entire circumference of the joint.

The adhesive material 32 has gluing properties. Advantageously, the adhesive material is or includes structural epoxy adhesive.

In general, the adhesive material is in the form of a hardenable component which can be spread over the faces of the segments to coat the latter (at least locally).

Advantageously, for part or all of the joint Ji-1/i, the adhesive material 32 used therein initially presents itself in the form of one or more sheet of solid adhesive material. Each sheet is then applied onto one of the faces defining the joint therebetween.

Here, by “solid”, it is understood that in this form, the adhesive material does not drip, but is nonetheless adapted to be spread onto the face of the segment onto which it is applied.

In embodiments in which the portions Bi and Ti-1 solely define part of the corresponding faces, a greater quantity of adhesive material, for instance per surface unit of the corresponding faces, is used in regions of the joint defined between corresponding regions of the faces which are not defined by these portions, compared to the regions which are.

In addition, whether during step S5 or before, and in particular in embodiments in which the portions Bi and Ti-1 solely define part of the corresponding faces, advantageously, at least one of the faces UFi-1, LFi is processed so as to increase the gap between this face and the face of the other segment in at least one region of the considered face which is not defined by the corresponding portion Bi, Ti-1. For instance, the gap is increased in all the regions of the joint Ji-1/i which are not defined by the portions Bi, Ti-1. For instance, the increase in gap is of a few millimeters. For example, this increase is of 2 or 3 mm.

Both faces may be processed so as to increase the gap. Alternatively, only one may be processed.

In effect, the constitution of the joint described here may be reproduced for every pair of superimposed segments, whether obtained through the process according to the invention or not.

In addition, alternatively or in parallel, the processing of the faces of the segments described may be carried out for all the segments which are obtained by the process according to the invention, or for only part of them.

The invention presents several advantages.

In particular, the configuration of the faces UFi-1 and LFi of the segments Si-1 and Si have an enhanced complementarity due to the principle of the portion Bi and Ti-1 being complementary in shape, but the manufacturing of the segments themselves does not require that the segment be made in a specific order. For instance, in some embodiments, the segments Si and Si-1 are simultaneously cast, this configuration being simply impossible in the context of a typical conjugated approach. As such, the invention may be seen as a pseudo-conjugated approach, or pseudo-match cast approach, compared to the conjugated approach, also known as a match-cast approach.

The invention also provides advantages in terms of the space which is required for manufacturing the segments, since there is no need to place and adjust the position of segment Si-1 below the mould Mi before casting segment Si.

In addition, the shape complementarity of the faces LFi and UFi-1 with a high degree of precision is easily reproducible and is therefore cost-effective, in particular compared to high-precision computer-controlled machining techniques which may be employed to obtain the desired precision for the segments.

1. A method of manufacturing precast concrete segments destined to form all or part of a tower, the segments being destined to be superimposed within the tower, the method comprising, for at least a first segment and a second segment destined to be adjacent in the tower, the first segment being destined to be located beneath the second segment, forming said first and second segments using at least one mould comprising a first portion and a second portion respectively configured to define all or part of an upper face, respectively a lower face of the segment formed therein, the first portion of the mould used for forming the first segment and the second portion of the mould used for forming the second segment exhibiting respective geometries of complementary shapes.

2. The method according to claim 1, further comprising a step of manufacturing the first portion of the mould used for forming the first segment and the second portion of the mould used for forming the second segment, wherein at least one of the first portion of the mould used for forming the first segment and the second portion of the mould used for forming the second segment is formed in contact with the other one among the first portion of the mould used for forming the first segment and the second portion of the mould used for forming the second segment so as to form the respective geometries of complementary shapes.

3. The method according to claim 2, wherein the first portion of the mould used for forming the first segment and the second portion of the mould used for forming the second segment are simultaneously formed in contact with one another.

4. The method according to claim 2, wherein a first element among the first portion of the mould used for forming the first segment and the second portion of the mould used for forming the second segment is initially made and a second element among the first portion of the mould used for forming the first segment and the second portion of the mould used for forming the second segment is made by casting using a mould which includes the first element configured so as to generate the geometry of the second element by shape complementarity.

5. The method according to claim 1, wherein the respective geometries of the upper face of the first segment and of the lower face of the second segment define at least one shear key when cooperating with one another.

6. The method according to claim 5, wherein the shear key is defined by a mortise and a tenon respectively defined within one element among the upper face of the first segment and the lower face of the second segment.

7. The method according to claim 1, wherein the first portion of the mould used for forming the first segment and the second portion of the mould used for forming the second segment define the entirety of the corresponding face of the corresponding segment.

8. The method according to claim 7, wherein the segments have a general cylindrical shape, the first portion of the mould used for forming the first segment and the second portion of the mould used for forming the second segment each including a plurality of components which are assembled together to cover the entire circumference of the corresponding face of the corresponding segment.

9. The method according to claim 1, wherein the first portion of the mould used for forming the first segment and the second portion of the mould used for forming the second segment define solely part of the corresponding face of the corresponding segment.

10. The method according to claim 1, wherein the first portion of the mould used for forming the second segment exhibits a geometry having a shape complementary to that of a geometry of a second portion of a mould used for forming a third segment destined to be adjacent to the second segment within the tower and to be located above the second segment, said second portion of the mould used for forming the third segment being configured to define a lower face of the third segment.

11. The method according to claim 1, wherein the mould used for forming the first segment and the mould used for forming the second segment are a same mould.

12. The method according to claim 1, wherein the mould used for forming the first segment and the mould used for forming the second segment are different moulds.

13. The method according to claim 1, wherein at least for one considered segment among the first or second segment, an angle defined between an upper average plane defined by the upper face of the considered segment and a lower average plane defined by the lower face of the considered segment is inferior to 0,5 milliradian.

14. The method according to claim 1, wherein at least for one considered segment among the first or second segment, the drift of said considered segment, which corresponds to a vertical misalignment between the upper face and the lower face of the segment Si, is inferior to 5 mm.

15. A method of manufacturing a tower, the tower comprising a plurality of superimposed precast concrete segments, the method comprising:
using the method according to claim 1, manufacturing at least a first and a second segments destined to be adjacent in the tower, the first segment being destined to be located underneath the second segment, and
superimposing the segments including the first and second segments to form the tower.
